(19) United States
(12) Patent Application Publication
(10) Pub. No.: US 2008/0213012 A1
(43) Pub. Date: Sep. 4, 2008

(54) DISCHARGE GUIDE AND IMAGE FORMING APPARATUS HAVING THE SAME

(75) Inventor: BYUNG-SUN AHN, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/872,284

(22) Filed: Oct. 15, 2007

(30) Foreign Application Priority Data
Mar. 2, 2007 (KR) 2007-21009

(51) Int. Cl. G03G 15/20

(52) U.S. Cl. 399/322

(57) ABSTRACT

A discharge guide of an image forming apparatus. The discharge guide includes: a guide body disposed between a fixing unit and a discharging unit of the image forming apparatus; and a guide member disposed on the guide body. The guide member includes a guide edge, which forms different amounts of gap with a central portion end portions of a heating roller of the fixing unit.

### CROSS-REFERENCE TO RELATED APPLICATION

This application claims the benefits of Korean Application No. 2007-21009, filed Mar. 2, 2007, in the Korean Intellectual Property Office, the disclosure of which is incorporated herein by reference.

### BACKGROUND OF THE INVENTION

1. Field of the Invention

Aspects of the present invention relate to a discharge guide and an image forming apparatus including the same.

2. Description of the Related Art

FIG. 1 is a view illustrating an image forming apparatus in which a general electrophotographic process is used. In FIG. 1, the image forming apparatus includes a feeding unit 10, a developing unit 20, a laser scanning unit (LSU) 23, a transfer belt 30, a fixing unit 40, and a discharging unit 50. The feeding unit 10 receives a plurality of sheets of paper and continuously feeds the sheets of paper to the developing unit 20, using a pick-up unit 11.

The developing unit 20 stores toner, supplies the toner onto an electrostatic latent image on a photosensitive medium corresponding to a print digital signal and develops the electrostatic latent image into a toner image. In the case of an image forming apparatus capable of color printing, a plurality of developing units are included in which cyan, magenta, yellow, and black toner are respectively stored, and the developing units each include a separate photosensitive medium 21.

The LSU 23 directs a laser beam to each of the photosensitive mediums 21, to form an electrostatic latent image corresponding to a digital print signal. As shown in FIG. 1, a single laser scanning unit 23 may expose the plurality of photosensitive mediums 21. A plurality of laser scanning units 23 may be provided, which respectively corresponding to the plurality of photosensitive mediums 21.

The transfer belt 30 transfers the toner image, developed by the plurality of developing units 20 on each photosensitive medium 21, to a sheet of paper P. In other words, if a sheet of paper P enters between the transfer belt 30 and the photosensitive medium 21, the toner images developed on each photosensitive medium 21 may be sequentially transferred onto the sheet of paper P, using a high voltage. A visible image may thereby be formed on the sheet of paper P.

As shown in FIG. 2, the fixing unit 40 includes a heating roller 41 and a pressure roller 42. The heating roller 41 is heated to a preset temperature, and applies the heat to the sheet of paper P on which the visible image is formed. The pressure roller 42 rotates while pressing against the heating roller 41, to fix the visible image onto a surface of the sheet of paper P.

The discharging unit 50 includes a plurality of discharging rollers 51, to discharge the sheet of paper P, passing through the fixing unit 40, to the outside of the image forming apparatus 1. A discharge guide 60 is disposed between the fixing unit 40 and the discharging unit 50, and guides the sheet of paper P passing through the fixing unit 40, to the discharging unit 50. The discharge guide 60 is spaced from the fixing unit 40 at a distance D. The discharging guide 60 and the fixing unit 40 face each other, and extend across the width of a sheet of paper P.

In the general image forming apparatus 1, if an image having a high toner density is formed within approximately 0 to 10 mm of a leading end of the sheet of paper, the sheet of paper may be jammed in the gap between the discharge guide 60 and the heating roller 41. This jam may be due to the leading end of the sheet of paper being curled towards the heating roller 41, by the heat generated by the heating roller 41, along a paper transfer path indicated by a solid line in FIG. 2.

This type of jam is referred to as a wrap jam. In order to prevent a wrap jam, a mono-color image forming apparatus prevents the sheet of paper, passing through the fixing unit 40, from being jammed in a gap, by making the gap between the discharge guide 60 and the heating roller 41 as narrow as possible, or by using a separate member, such as a separate claw.

In a color image forming apparatus, the heating roller 41 is made of an elastic material, so it is impossible to prevent a sheet of paper from being jammed in the gap between the discharge guide 60 and the heating roller 41, by using a separate claw in the same manner as in a mono-color image forming apparatus. Specifically, when a heating roller 41 made of elastic material is in contact with a separate claw, the surface of the heating roller 41 is damaged. Accordingly, fixing errors may occur, or the fixing unit 40 may be incapable of operating.

If the discharging guide 60 is disposed very close to the heating roller 41, the discharging guide 60 may be deformed by the heat from the fixing unit 40, and the gap between the discharging guide 60 and the heating roller 41 may become too narrow. Accordingly, the heating roller 41 and discharging guide 60 may interfere with each other, and the discharge guide 60 may damage the surface of the heating roller 41.

The discharge guide 60 is generally disposed in a straight line, parallel to the length of the heating roller 41. Since the heating roller 41 does not evenly heat the discharge guide 60, there is a difference in the degree of thermal deformation for different portions of the discharge guide 60. Therefore, a regular gap between the discharging guide 60 and the heating roller 41 cannot be maintained.

If an image forming apparatus is constructed so that the gap between the discharging guide 60 and the heating roller 41 is maintained within a predetermined range, even a slight skew in the sheet of paper P may cause an edge of the sheet of paper P, to become jammed in the gap between the discharging guide 60 and the heating roller 41, resulting in a wrap jam.

A separate member may be mounted within a range, without damaging the surface of the heating roller 41, in order to prevent the sheet of paper P from being jammed in the gap. However, a complicated construction must be implemented in order to maintain a consistent accuracy during an assembling operation and to maintain a regular gap between the discharging guide 60 and the heating roller 41. Accordingly, the cost of materials can increase.

### SUMMARY OF THE INVENTION

Aspects of the present invention relate to a discharge guide and an image forming apparatus having the discharge guide, which have an improved structure, so that a gap between a discharge guide and a heating roller can be maintained.

Aspects of the present invention relate to a discharge guide and an image forming apparatus having the discharge guide, which can prevent damage to, or a malfunction of, a heating roller due to a thermal deformation of the discharge guide. A wrap jam, due to a paper skew, when there is a difference in the time at which right and left sides of the sheet of paper enter, can also be prevented.

According to aspects of the present invention, there is provided a discharge guide of an image forming apparatus, including: a guide body disposed between a fixing unit and a discharging unit of the image forming apparatus; and a guide member mounted on the guide body. The guide member includes a guide edge, which forms a gap that varies in width between itself and a heating roller. The width of the gap can vary from a central portion of a heating roller to end portions of the heating roller.

A side surface of the guide member may be curved along a length thereof. A central portion of the guide member may protrude upwardly, relative to both end portions of the guide member. If a distance from one end portion of the guide member, to a center of rotation of the heating roller is R1, and a distance from the central portion of the guide member to the center of rotation of the heating roller is R2, R1 may be greater than R2.

A distance A can be between the central portion of the guide edge and the heating roller. The distances B and C are between the end portions of the guide edge and the heating roller. The distance B may be equal to the distance C. The distance B and the distance C may be greater than the distance A. The distance B may be equal to the distance C, and the distances B and C may be greater than the distance A. A distance between the guide edge and the fixing unit may be from approximately 0.3 to 3 mm. The narrowest distance between the guide edge and the fixing unit may be approximately 0.5 mm. The widest distance between the guide edge and the fixing unit may be approximately 1.0 mm.

The guide member may be integrally formed with the guide body. The guide member may be bent at an inflection point H, where the guide member is attached to the in the guide body. The guide member may be configured so as to be deformed about the inflection point H, during a thermal deformation.

According aspects of the present invention, provided is a discharge guide of an image forming apparatus, including: a guide body disposed between a fixing unit and a discharging unit of the image forming apparatus; and a guide member mounted on the guide body. The guide member can include a guide edge, which faces a heating roller mounted on the fixing unit. The guide member can have a curved shape, so that a distance between the guide edge and a central portion of the fixing unit may be different from distances between the guide edge and both end portions of the fixing unit.

A gap between the guide edge and the fixing unit may have a width ranging from approximately 0.3 to 3 mm. The smallest width of the gap between the guide edge and the fixing unit may be approximately 0.5 mm. The largest width of the gap between the guide edge and the fixing unit may be approximately 1.0 mm.

According various aspects of the present invention, there is provided an image forming apparatus including: a feeding unit to receive a sheet of paper; a developing unit to print a visible image onto the sheet of paper supplied by the feeding unit; a fixing unit to apply heat and pressure to the visible image printed on a surface of the sheet of paper, to fuse the image thereto; a discharging unit to discharge the sheet of paper having the fused image, to the outside of the image forming apparatus; and a discharge guide, disposed between the fixing unit and the discharging unit, to guide the sheet of paper, as the sheet of paper passes through the fixing unit towards the discharging unit.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the various embodiments, taken in conjunction with the accompanying drawings, of which:

FIG. 1 is an exemplary view schematically illustrating a general image forming apparatus;

FIG. 2 is a view illustrating a discharge guide of FIG. 1;

FIG. 3A is a perspective view illustrating a discharge guide, according to an exemplary embodiment of the present invention;

FIG. 3B is a schematic view of an image forming apparatus, according to aspects of the present invention;

FIG. 4 is a plane view schematically illustrating an arrangement of a discharge guide and a heating roller, according to an exemplary embodiment of the present invention;

FIG. 5 is a view schematically illustrating a difference in heights of a discharge guide and a guide edge, according to an exemplary embodiment of the present invention;

FIG. 6 is a view schematically illustrating the direction of thermal deformation of a discharge guide, according to an exemplary embodiment of the present invention; and

FIGS. 7A and 7B are sectional views cut following arrows I-I and II-II in FIG. 4.

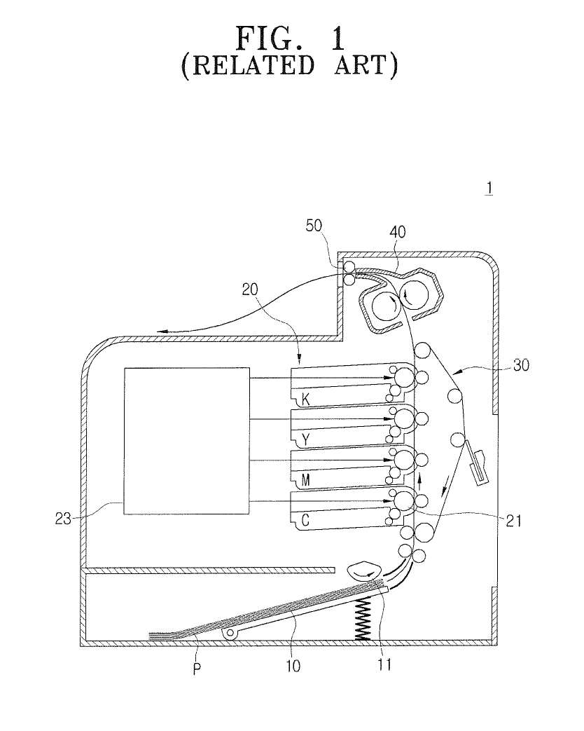

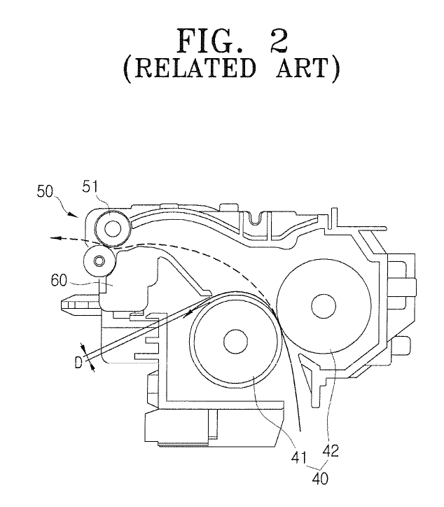

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

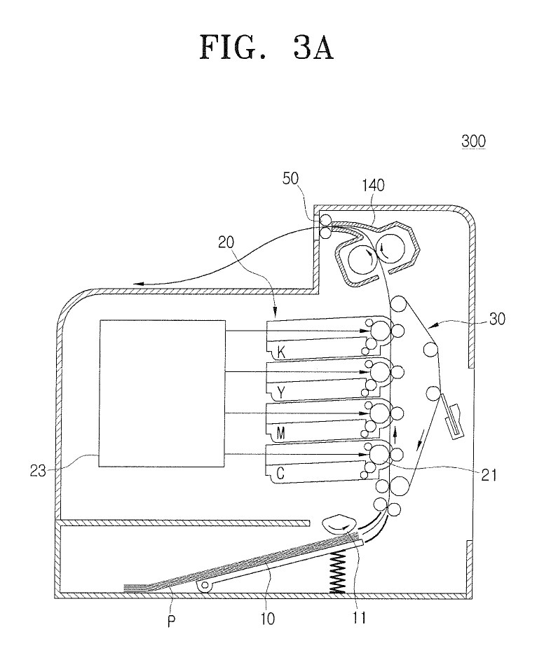

FIG. 3A illustrates an image forming apparatus 300, according to an exemplary embodiment of the present invention. The image forming apparatus 300 includes a feeding unit 10, a developing unit 20, a transfer unit 30, a fixing unit 140, and a discharging unit 50. The feeding unit 10, developing unit 20, transfer unit 30, and discharging unit 50 are conventional elements, so descriptions thereof are omitted.

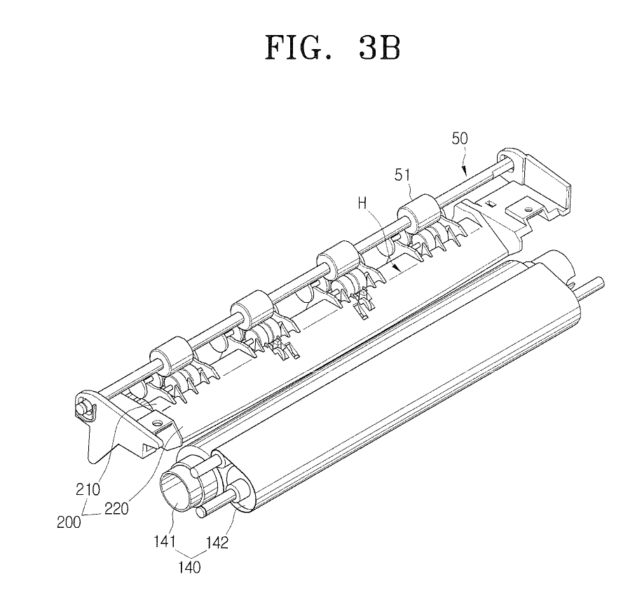

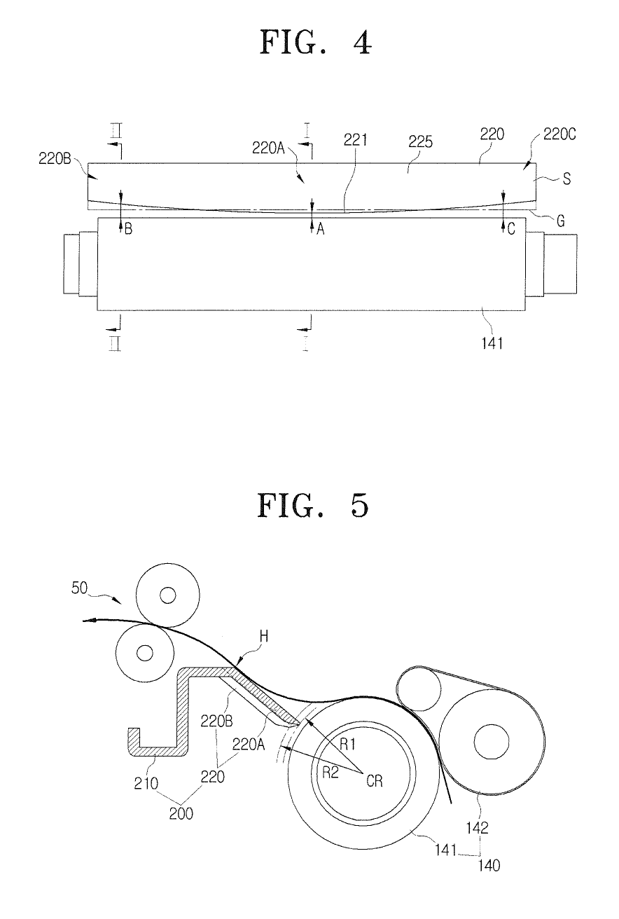

FIG. 3B is a schematic view illustrating the fixing unit 140 and the discharge guide 200. FIGS. 4 and 5 illustrate arrangements of the discharge guide 200 and the fixing roller 140. The discharge guide 200 is mounted between the fixing unit 140 and the discharging unit 50. The fixing unit 140 includes a heating roller 141 and a pressure belt 142. The heating roller 141 includes a heat source, and rotates in contact with the pressure belt 142. The pressure belt 142 can be tightly mounted to the heating roller 141, so that a fixing nip can be formed between the pressure belt 142 and heating roller 141. The fixing nip is the position where heat and pressure are applied to a sheet of paper P, as the sheet of paper P passes there through.

The discharge guide 200 includes a guide body 210 and a guide member 220. The guide body 210 is disposed adjacent to a paper transfer path between the fixing unit 140 and the discharging unit 50. The guide member 220 is mounted to the guide body 210, so as to extend toward and/or face the heating roller 141 along the paper transfer path. The guide member 220 guides the sheet of paper P, passing through the fixing unit 140, to the discharging unit 50.

The guide member 220, according to an exemplary embodiment of the present invention, is integrally formed with the guide body 210. The guide member 220 can include an inflection point H. The guide member can be bent at the inflection point H. A side surface 225 of the guide member 220 can be curved along its length. For example, the side surface 225 of the guide member 220 can be bowed away from the guide body 210 (toward the paper transfer path), such that a central portion of the side surface 225 is further from the guide body 210 (toward the paper transfer path) than end portions of the side surface 220C.

The guide member 220 includes a guide edge 221, which defines a portion of a gap G, in conjunction with the heating roller 141. The guide edge 221 can be curved, A distance A, between a central portion of the heating roller 141 and a central portion 220A of the guide member 220, is different from distances B and C, which are between end portions of the heating roller 141 and end portions 220B and 220C of the guide member 220. In other words, the central portion 220A (also indicated by hashed lines in FIG. 5) of the guide member 220 protrudes upward (toward the paper transfer path) relative to both of the end portions 220B and 220C of the guide member 220. A distance R2 is a distance from the end portions 220B of the guide member 220, to a center of rotation CR of the heating roller 141. A distance R1 is a distance from the central portion 220A of the guide member 220 to the center of rotation CR. The distance R2 can be greater than the distance R1.

In the construction described above, even if a paper skew occurs, and an edge of a sheet of paper enters the gap between the discharge guide 200 and the heating roller 141, the sheet of paper can be picked up by either the end portions 220B and 220C of the guide member 220, which are downwardly inclined (away from the paper transfer path). Therefore, a sheet of paper can be guided by the discharge guide 200, towards the discharging unit 50, without the sheet of paper becoming wrapped around the heating roller 141.

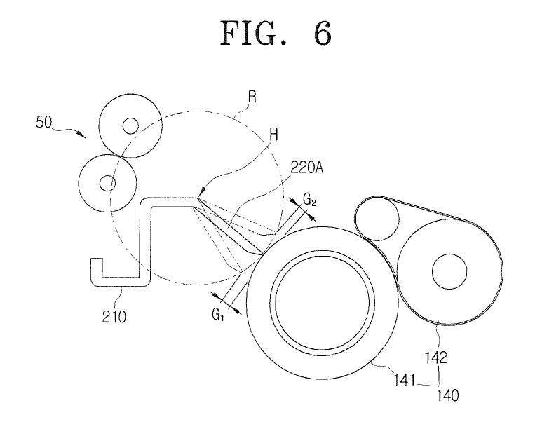

FIG. 6 is a view illustrating a situation in which the discharge guide 200 is deformed by heat from the fixing unit 140. As shown in FIG. 6, the guide member 220 can be bent or deformed in a clockwise or a counterclockwise direction, at or around the inflection point H. For example, the guide member can be bent along a dotted arc R. A distance between the guide member 220 and the heating roller 141 can increase as the guide member is bent. In this manner, if the guide member 220 bends along a rotation path indicated by dotted line R in FIG. 6. Gaps G1 and G2, between an end of the guide member 220 and the heating roller 141, can be greater than a gap between the end of the guide member 220 and the heating roller 141, prior to the thermal deformation.

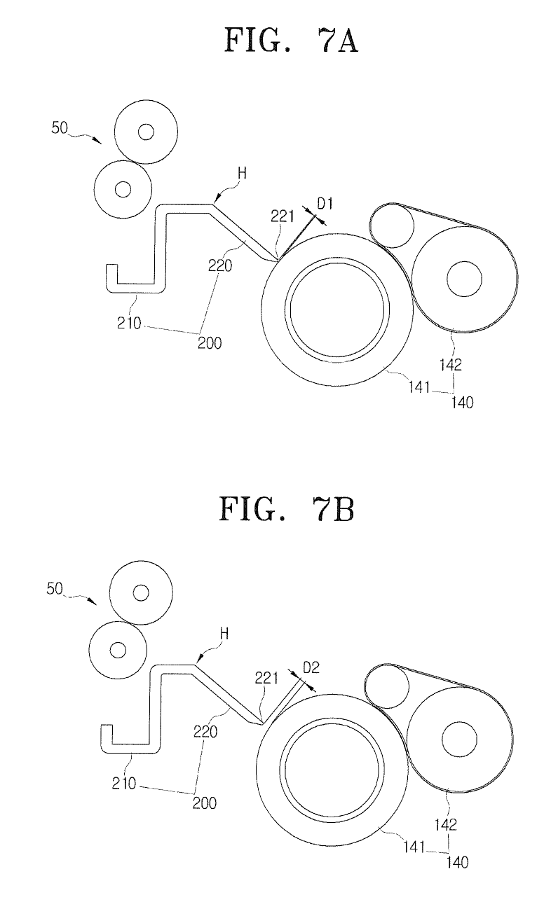

FIG. 7A is a sectional view cut following arrow I-I, at point A, in FIG. 4, and FIG. 7B is a sectional view cut following arrow II-II, in FIG. 4. The guide member 220, according to an exemplary embodiment of the present invention, includes a guide edge 221, which has a curved shape and faces the heating roller 141 mounted to the fixing unit 140.

The discharge guide 200 includes the guide body 210 and the guide member 220, both of which are disposed between the fixing unit 140 and discharging unit 50, of the image forming apparatus 300. The guide member 220 is integrally formed with the guide body 210, and can be bent at the inflection point H, so as to vertically face the fixing unit 140.

The guide edge 221 of the guide member 220 is curved. A distance A, from a central portion of the heating roller 141 to a central portion of the guide edge 221, can be different from distances B and C from end portions of the heating roller 141 to end portions of the guide edge 221. The distances A, B, and C may satisfy the equation B=C>A. The gap, between the heating roller 141 and the guide edge 221 of the guide member 220, may have a width ranging from approximately 0.3 to 3 mm. As shown in FIG. 7, a distance D1 may be approximately 0.5 mm, and the distance D2 may be approximately 1.0 mm. The distance D1 can be equal to the distance A. The distance D2 can be equal to either of the distance A or the distance B. The distances A, B, and C can represent the width of the gap.

Hereinafter, the operation of the image forming apparatus, according to exemplary embodiments of the present invention, will be described with reference to the accompanying drawings. A sheet of paper P in the feeding unit 10 is picked up by a pick up unit 11 and passes through the developing unit 20 and the transfer unit 30, while a toner image is transferred onto a surface of the sheet of paper. Heat and pressure are applied to the toner image, and the toner image is fused onto the surface of the sheet of paper P, while the sheet of paper P passes through the fixing unit 140.

The amount of heat applied to the guide member 220 may change, depending on the toner image formed on the sheet of paper P. For example, if an image having a high toner density is printed onto a sheet of paper P, a large amount of heat can be generated by the heating roller 141 and applied to the toner image, in order to fuse the toner image. Accordingly, less heat may be applied to the guide member 220 in portions on which the toner image is formed, relative to portions on which the toner image is not formed, that is, blank portions at both ends of the sheet of paper.

Therefore, the central portion 220A (shown in FIG. 4) of the guide member 220, faces a central portion of the sheet of paper P bearing an image with a high toner density, is slightly deformed by the heat, compared to the end portions 220B of the guide member 220, which face blank portions at both ends of the sheet of paper.

The guide member 220 of the discharge guide 200 faces the heating roller. As shown in FIG. 4, the distance A, where the central portion 220A of the guide member 220 is closest to the central portion of the heating roller 141, forms the narrowest portion (width) of the gap G, between the guide member 220 and the heating roller 141. The distances B and C, where end portions 220A and 220B of the guide member 220 are furthest from the heating roller 141, form the widest portions (widths) of the gap G.

When the guide member 220 is formed as described above, the discharge guide 200 can be deformed by heat, to prevent interference with the surface of the heating roller 141, even if the image with a high toner density is formed on the sheet of paper P, passing through the fixing unit 140. In other words, according to an exemplary embodiment of the present invention, when the side surface S of the guide member 220 is curved along its length, so that the distance A, from the central portion of the heating roller 141 to the guide edge 221, is less than the distances B and C, the distances A, B, and C may satisfy the equation B=C>A. Accordingly, the heating roller 141 is further from the guide edge 221 at end portions 220B and 220C, where a higher temperature/more heat is applied. Therefore, the amount of heat applied to the end portions 220B and 220C may be reduced, and an interference with the surface of the heating roller 141 can also be prevented, even if a large amount of thermal deformation occurs.

As shown in FIG. 6, the guide member 220 is configured so as to be deflected about the inflection point H, if the guide member 220 is deformed by heat. The guide member 220 can bend clockwise or counterclockwise, according to the thermal stress, during the thermal deformation, as indicated by dotted arc R in FIG. 6. In this situation, the end (edge) of the guide member 220, which is closest to the heating roller 141, becomes further from the heating roller 141 along the rotation path indicated by arc R, in FIG. 6. Thus, it is possible to prevent an interference between the guide member 220 and the heating roller 141, due to the thermal deformation.

Since the side surface S of the guide member 220 is curved along its length, the end portions 220B and 220C of the guide member 220 are downwardly inclined (away from a paper transfer path) as compared to the central portion 220A of the guide member 220. Accordingly, even if the paper skew occurs, and one or more of the edge portions of the sheet of paper pass through the fixing unit 140 earlier than a central portion of the sheet of paper, the edge portions come into contact with the guide member 220 to prevent a wrap jam from occurring when the edge portions become jammed in the gap G, due to a paper skew.

According to an exemplary embodiment of the present invention, when the guide edge 221 of the guide member 220 has a curved shape, the distance D2 at points edge portions 220B and 220C of the guide member 220, to which a high temperature is applied relative to the central portion 220A, can be greater than a distance D1 to the central portion 220A of the guide member 220. Accordingly, even if the degree of thermal deformation, of the end portions 220B and 220C of the guide member 220, is greater than that of the central portion 220A of the guide member 220, there is no interference between the heating roller 141 and the guide member 220.

The guide member 220, according to an exemplary embodiment of the present invention, can also rotate about the inflection point H, so if the guide member 220 is deformed by the heat, the guide member 220 can rotate clockwise or counterclockwise according to the thermal stress during the thermal deformation, as indicated by dotted line R in FIG. 6. In this situation, the end part of the guide member 220, which is closest to the heating roller 141 becomes further from the heating roller 141, along the deformation path indicated by dotted arc R, in FIG. 6. Thus, it is possible to prevent an interference between the guide member 220 and the heating roller 141, due to the thermal deformation.

As described above, according to the exemplary embodiments of the present invention, it is possible to prevent a wrap jam from occurring when an image with a high toner density is formed on the leading end of the sheet of paper, or when there is a difference in the time at which the right and left sides of the sheet of paper enter, due to a paper skew.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A discharge guide of an image forming apparatus, comprising:
a guide body disposed between a fixing unit and a discharging unit of the image forming apparatus; and
a guide member mounted on the guide body, the guide member including a guide surface which forms different amounts of gap with a central portion of a heating roller mounted on the fixing unit and with both end portions of the heating roller.

2. The discharge guide according to claim 1, wherein the guide member has a side surface that is curved along a length thereof.

3. The discharge guide according to claim 2, wherein a central portion of the guide member protrudes toward a paper transfer path, relative to end portions of the guide member, and the paper transfer path extends from the heating roller to the discharging unit.

4. The discharge guide according to claim 3, wherein a distance from one of the end portions to a center of rotation of the heating roller is greater than a distance from the central portion to the center of rotation of the heating roller.

5. The discharge guide according to claim 4, wherein the width of the gap increases from the central portion thereof to the end portions thereof.

6. The discharge guide according to claim 5, wherein the width of the gap increases from approximately 0.3 to 3 mm.

7. An image forming apparatus comprising:
a feeding unit to receive a plurality of sheets of paper;
a developing unit to print a visible image onto a sheet of paper supplied by the feeding unit;
a fixing unit to apply heat and pressure to fuse the visible image to the sheet of paper;
a discharging unit to discharge the fused sheet of paper outside of the image forming apparatus; and
a discharge guide, disposed between the fixing unit and the discharging unit, to guide the sheet of paper along a paper transfer path from the fixing unit to the discharging unit,
wherein the discharge guide comprises:
a guide body disposed between the fixing unit and the discharging unit of the image forming apparatus; and
a guide member mounted on the guide body, the guide member including a guide edge disposed adjacent to a heating roller of the fixing unit, to form a gap therebetween, the gap having a width that varies from a central portion thereof to end portions thereof.

8. The image forming apparatus according to claim 7, wherein a side surface of the guide member is curved along a length thereof toward the paper transfer path.

9. The image forming apparatus according to claim 8, wherein a central portion of the guide member extends toward the paper transfer path and end portions of the guide member extend away from the paper transfer path.

10. The image forming apparatus according to claim 9, wherein a distance from one of the end portions to a center of rotation of the heating roller is greater than a distance from the central portion to the center of rotation of the heating roller.

11. The image forming apparatus according to claim 10, wherein the width of the gap increases from the central portion thereof to the end portions thereof.

12. The image forming apparatus according to claim 11, wherein the width of the gap increases from approximately 0.3 to 3 mm.

13. The image forming apparatus according to claim 12, wherein the width of the gap increases from approximately 0.5 mm to 1.0 mm.

14. The image forming apparatus according to claim 7, wherein the guide member is integrally formed with the guide body.

15. The image forming apparatus according to claim 14, wherein the guide member is attached to the guide body at an inflection point and is bent relative to the guide body at the inflection point.

16. The image forming apparatus according to claim 15, wherein in response to a change in temperature, the guide member is configured to bend at inflection point.

17. A discharge guide of an image forming apparatus, comprising:
a guide body disposed between a fixing unit and a discharging unit of the image forming apparatus; and
a guide member mounted on the guide body, the guide member including a guide edge which faces a heating roller mounted on the fixing unit and is curved such that a first distance between the a central portion of the guide edge and a central portion of the heating roller is different from second and third distances respectively between end portions of the guide edge and respective end portions of the heating roller.

18. The discharge guide according to claim 17, wherein the second and third distances are equal and are greater than the first distance.

19. The discharge guide according to claim 18, wherein the first, second, and third distances are between approximately 0.3 to 3 mm.

20. The discharge guide according to claim 19, wherein the first distance is approximately 0.5 mm, and the second and third distances are each approximately 1.0 mm.

21. A discharge guide of an image forming apparatus including a heating roller and a discharging unit, the discharge guide comprising:
a guide body disposed between the heating roller and the discharging unit; and
a guide member mounted on the guide body, the guide member including a guide edge curving toward the heating roller and a side surface curving toward a paper transfer path between the heating roller and the discharge guide,
wherein the guide edge and the heating roller are disposed to form a gap therebetween, the gap having a width that varies from a central portion thereof to end portions thereof
